(19) United States
(12) Patent Application Publication
(10) Pub. No.: US 2011/0252085 A1
(43) Pub. Date: Oct. 13, 2011

(54) COMMUNICATION SYSTEM, SERVER DEVICE, DISPLAY DEVICE, INFORMATION PROCESSING METHOD, AND PROGRAM

(76) Inventors: Go Mase, Tokyo (JP); Tadashi Haneishi, Tokyo (JP); Nobuyuki Enomoto, Tokyo (JP); Yasunori Okajima, Tokyo (JP)

(21) Appl. No.: 12/998,961

(22) PCT Filed: Jan. 20, 2010
(86) PCT No.: PCT/JP2010/050627

§ 371 Date: Jun. 20, 2011

(30) Foreign Application Priority Data
Jan. 28, 2009 (JP) 2009-016601

(51) Int. Cl. G06F 15/16

(52) U.S. Cl. 709/203

(57) ABSTRACT

A communication system according to the present invention has a display device (10) including a storage unit that stores a plurality of contents and contents identifiers which are different from contents, and a controller that successively outputs the contents and, when one of the contents is selected, sends a contents identifier corresponding to the selected one of the contents to a network, and a server (20) including a storage unit that stores processing items for the respective contents and a controller that, when the contents identifier is received from the display device via the network, generates a contents page including the processing item corresponding to the contents of the contents identifier.

### TECHNICAL FIELD

The present invention relates to a communication system, a server device, a display device, an information processing method, and a program.

### BACKGROUND ART

Digital photo frames have been used as picture frames for successively displaying a plurality of pictures captured by digital cameras. If the user of a digital photo frame wants to utilize images displayed by the digital photo frame on another terminal or to obtain information about those displayed images, then the user needs to copy the images from the digital photo frame to a medium, connect the medium to another information terminal, and send the images thereto, or to input information obtained from the digital photo frame to an information terminal connected to a network and check the information.

JP-A No. 2007-110557 (hereinafter referred to as Patent document 1) discloses an apparatus for eliminating such inconveniences. According to the disclosed apparatus, a digital photo frame incorporates a web browser function which makes it possible for the user to see web pages on the Internet with the digital photo frame.

JP-A No. 2007-088846 (hereinafter referred to as Patent document 2) discloses another apparatus. According to the disclosed apparatus, a digital photo frame incorporates an electronic mail function for sending mails the digital photo frame to another terminal.

### SUMMARY OF THE INVENTION

If the user of a digital photo frame wants to search for information with the digital photo frame alone, then as disclosed in Patent document 1 or Patent document 2, the digital photo frame needs to incorporate a web browser function and an electronic mail function on personal computers (hereinafter referred to as PC). However, since the digital photo frame requires a controller such as a high-performance CPU on PCs and an input device such as a keyboard, the digital photo frame becomes costly and large in size.

An exemplary object of the present invention is to provide a communication system, a server device, a display device, an information processing method, and a program which prevent a display device such as a digital photo frame from becoming costly and large in size and which are capable of simply processing contents output to the display device in various ways.

A communication system according to an exemplary aspect of the present invention includes a display device including a storage unit that stores a plurality of contents and contents identifiers which are different from contents, and a controller that successively outputs the contents and, when one of the contents is selected, sends a contents identifier corresponding to the selected one of the contents to a network, and a server including a storage unit that stores processing items for the respective contents and a controller that, when the contents identifier is received from the display device via the network, generates a contents page including the processing item corresponding to the contents of the contents identifier.

A communication system according to an exemplary aspect of the present invention includes a display device including a storage unit that stores a plurality of contents and contents identifiers which are different from contents, and a controller that successively outputs the contents and, when one of the contents is selected, sends a contents identifier corresponding to the selected one of the contents to a network, and a server including a storage unit that stores character entry items for the respective contents and a controller that, when the contents identifier is received from the display device via the network, generates a contents page including an entry field for the character entry item corresponding to the contents of the contents identifier, and sends information for acquiring the contents page to an information processing device having a character input unit via the network.

A server device according to an exemplary aspect of the present invention, that is connected through a network to a display device for successively outputting a plurality of contents, includes a storage unit that stores processing items for the respective contents, and a controller that, when a contents identifier corresponding to a selected one of the contents is received from the display device, generates a contents page including the processing item corresponding to the contents of the contents identifier.

A display device according to an exemplary aspect of the present invention, that is connected through a network to a server for generating a web page related to a selected one of a plurality of contents, includes a storage unit that stores a plurality of contents and contents identifiers which are different from contents, a button for selecting one, which is being output, of the contents, and a controller that successively outputs the contents and, when the button is pressed, sends a contents identifier corresponding to the contents which is being output when the button is pressed.

An information processing method according to an exemplary aspect of the present invention, that is carried out by a server device which is connected through a network to a display device for successively outputting a plurality of contents, includes storing processing items for the respective contents, and when a contents identifier corresponding to a selected one of the contents is received from the display device, generating a contents page including the processing item corresponding to the contents of the contents identifier.

A program according to an exemplary aspect of the present invention, that is to be executed by a computer which is connected through a network to a display device for successively outputting a plurality of contents, enables the computer to carry out a process of storing processing items for the respective contents, and when a contents identifier corresponding to a selected one of the contents is received from the display device, generating a contents page including the processing item corresponding to the contents of the contents identifier.

### BRIEF DESCRIPTION OF THE DRAWINGS

FIG. 1 is a block diagram illustrative of a communication system according to a first exemplary embodiment of the present invention;

FIG. 2 is a block diagram showing a configurational example of a display device shown in FIG. 1;

FIG. 3 is a block diagram showing a configurational example of an information processing device shown in FIG. 1;

FIG. 4 is a block diagram showing a configurational example of a server shown in FIG. 1;

FIG. 5 is a table showing an example of user registration information;

FIG. 6 is a table illustrative of category type contents information;

FIG. 7 is a table showing an example of category type contents information;

FIG. 8 is a table illustrative of format type item information;

FIG. 9 is a table showing an example of format type item information;

FIG. 10 is a table showing an example of information about device types;

FIG. 11 is a view illustrative of a contents page;

FIG. 12 is a sequence diagram showing a sequence for registering a display device on a server;

FIG. 13 is a sequence diagram showing a sequence for registering the mail address of an information processing device;

FIG. 14 is a sequence diagram showing a sequence for storing contents in a display device;

FIG. 15 is a sequence diagram showing a sequence for acquiring an item about contents output to a display device;

FIG. 16 is a diagram showing an example of a URL management table;

FIG. 17 is a diagram showing an example of a format item information table;

FIG. 18 is a diagram showing an example of a category item information table;

FIG. 19 is a view showing an example of a contents page; and

FIG. 20 is a block diagram illustrative of a communication system according to a third exemplary embodiment of the present invention.

### MODE FOR CARRYING OUT THE INVENTION

### First Exemplary Embodiment

The configuration of a communication system according to the present exemplary embodiment will be described below. FIG. 1 a block diagram illustrative of a communication system according to the present exemplary embodiment.

As shown in FIG. 1, the communication system according to the present exemplary embodiment has display device 10 and server 20. Display device 10 and server 20 are connected to each other through network 50 such as the Internet. Information processing device 30 that is operated by the user of display device 10 is connected to the network. Display device 10 may be lent to the user by the administrator of server 20 or may be owned by the user. Each of the components will be described in detail below.

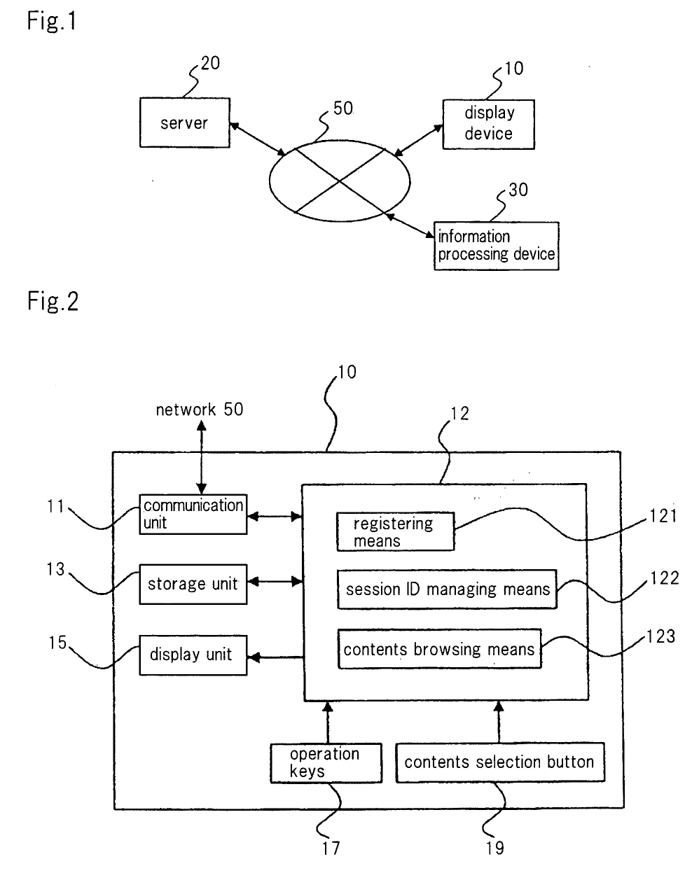

The configuration of display device 10 will be described below. FIG. 2 is a block diagram showing a configurational example of the display device shown in FIG. 1.

Display device 10 is a device for displaying images, such as a digital photo frame, a television, or a game machine. As shown in FIG. 2, display device 10 has communication unit 11 for connection to another device through network 50, storage unit 13 for storing image data, display unit 15 for displaying images, controller 12 for controlling parts of the display device, operation keys 17, and contents selection button 19. Since display device 10 is a device whose main object is to display images, it has simple operation keys 17 as an input means for the user. One of the features of display device 10 according to the present exemplary embodiment is that it has contents selection button 19 which is separate from operation keys 17.

For outputting sounds such as of music and voice, display device 10 includes a speaker, not shown, for outputting sounds.

Storage unit 13 has a device ID registered therein which serves as an identifier that is different from device to device. Display unit 15 comprises a liquid crystal display, for example. Operation keys 17 are used to instruct the controller to move cursor displayed on display unit 15 and determine a cursor stop position. Contents selection button 19 is used by the user to instruct the controller to choose from a plurality of images displayed on display unit 15.

Controller 12 has registering means 121, session ID managing means 122 for managing session IDs received from server 20, and contents browsing means 123 for displaying contents such as images received from server 20 on display unit 15. Details of operation of each of these means will be described with reference to sequences to be described later.

Controller 12 includes a CPU (Central Processing Unit) (not shown) for carrying out processing operations according to programs, and a memory (not shown) for storing the programs. When the CPU executes the programs, registering means 121, session ID managing means 122, and contents browsing means 123 are virtually set up in display device 10. However, the CPU included in controller 12 does not need to be equal in performance to CPUs included in server 20 and information processing device 30.

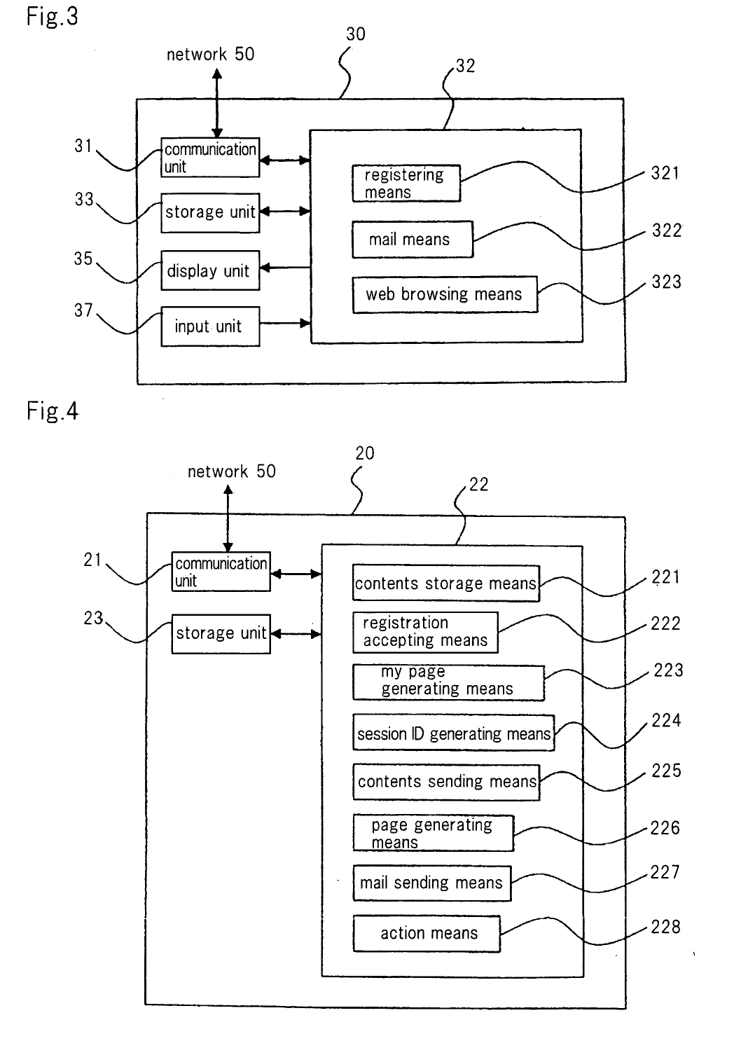

The configuration of information processing device 30 will be described below. FIG. 3 is a block diagram showing a configurational example of the information processing device shown in FIG. 1.

Information processing device 30 comprises an information processing terminal such as a mobile terminal, a PC, or the like. As shown in FIG. 3, information processing device 30 has communication unit 31 for connection to another device through network 50, storage unit 33 for storing information received from server 20, display unit 35 for displaying information stored in storage unit 33, controller 32 for controlling parts of the information processing device, and input unit 37 for entering instructions from the user. If information processing device 30 is a PC, then input unit 37 comprises a mouse and a keyboard. If information processing device 30 is a mobile terminal, then input unit 37 comprises character input keys and operation keys. The keyboard of a PC and the character input keys of a mobile terminal correspond to a character input unit.

Controller 32 has registering means 321, mail means 322 for displaying the contents of mails received from server 20 on display unit 35, and web browser means 323. Details of operation of each of these means will be described with reference to sequences to be described later.

Controller 32 includes a CPU (not shown) for carrying out processing operations according to programs, and a memory (not shown) for storing the programs. When the CPU executes the programs, registering means 321, mail means 322, and web browser means 323 are virtually set up in information processing device 30.

The configuration of server 20 will be described below. FIG. 4 is a block diagram showing a configurational example of the server shown in FIG. 1.

As shown in FIG. 4, server 20 has communication unit 21 for connection to another device through network 50, storage unit 23, and controller 22 for controlling parts of the server.

Storage unit 23 registers therein images to be delivered to display device 10. Data to be delivered are not limited to images such as moving images, photographs, etc., but may also include sounds such as of music, voice, etc., and character information such as of texts, etc. Data to be delivered which include images, sounds, character information, etc. will hereinafter be called “contents”. URLs that are indicative of areas where contents are registered in storage unit 23 will be referred to as contents storage URLs. In the present exemplary embodiment, it is assumed that contents to be delivered are mainly images.

Contents registered in storage unit 23 are classified and stored in storage 23 according to categories that are representative of service zones of contents or formats that are representative of data recording forms of contents. The categories include album, news, blog, and mail-order service. Album refers to the contents of images such as photographs that are registered by the user. Contents relative to news and mail-order service are registered by service providers.

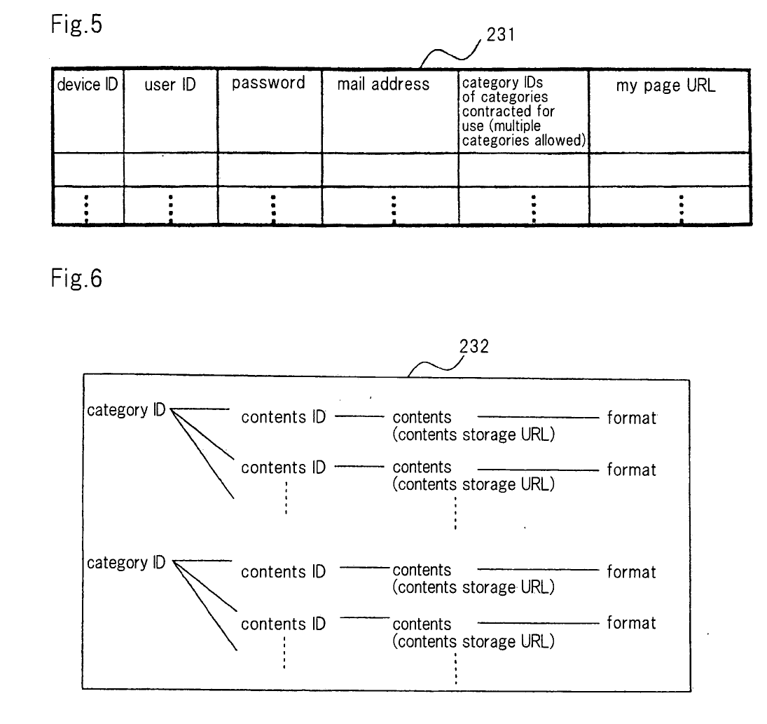

For contents management, storage unit 23 stores therein user registration information, category type contents information indicative of contents in categories, format type item information indicative of items in categories, and information about device types. As examples of these kinds of information, user registration information 231 is shown in FIG. 5, category type contents information 232 in FIG. 6, format type item information 233 in FIG. 8, and information 234 about device types in FIG. 10. Each of the different kinds of information will be described below.

FIG. 5 is a table showing an example of user registration information. As shown in FIG. 5, the user registration information includes device IDs which are different from device to device, user IDs which are different from user to user, passwords for user authentication, mail addresses of information processing devices 30, category IDs of categories contracted for use, and my page URLs, which are registered for respective users. The category IDs refer to identifiers which are different from category type to category type. The my page URLs refer to URLs of private web pages (my pages) that can be accessible only by users. Information other than the information shown in FIG. 5 may be registered as user registration information. Although not shown in FIG. 5, the types of information processing devices 30 such as mobile terminals or PCs may be registered. Registration codes and session IDs to be described later may be recorded as user registration information. Another table of device IDs and registration codes that are associated with each other and device IDs and session IDs that are associated with each other may also be provided.

A user who uses a service may be given a user ID at various stages. It is assumed hereinafter that a user is given a user ID by a service provider before the user receives a service provided by the service provider.

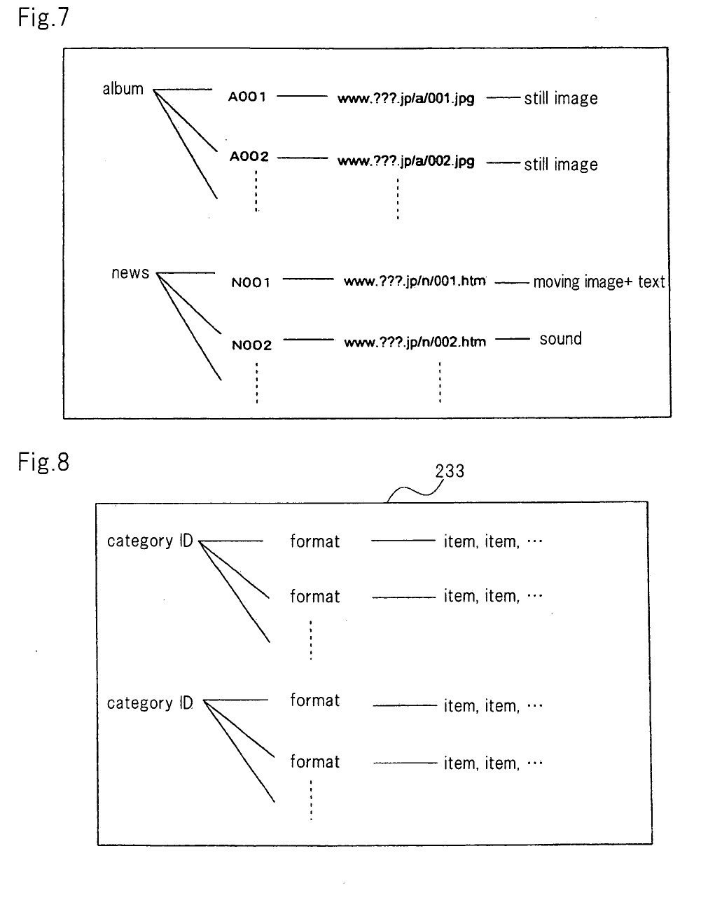

FIG. 6 is a table illustrative of category type contents information which is a system for managing contents stored in storage unit 23. FIG. 7 is a view showing an example of the table shown in FIG. 6. The table shown in FIG. 6 includes category IDs, contents IDs which are identifiers that are different from contents, contents storage URLs, and formats which are associated with each other. The number of formats is determined by the types of categories, and there may be a plurality of formats or there may be no format. When contents are stored in recording unit 23 for each of category types, a contents ID and a contents storage URL are determined, discriminated for a format, associated with each other, and stored. Based on contents, the table (association) is referred to for discriminating the category and format of the contents.

Category IDs are represented by a string of characters including numerals, such as contents IDs. For an easier understanding, FIG. 7 shows the types of categories. If a category refers to an album, as shown in FIG. 7, then contents IDs include A001 and A002, and contents URLs and formats are described which correspond to the contents IDs. The format for the content ID A001 represents a still image.

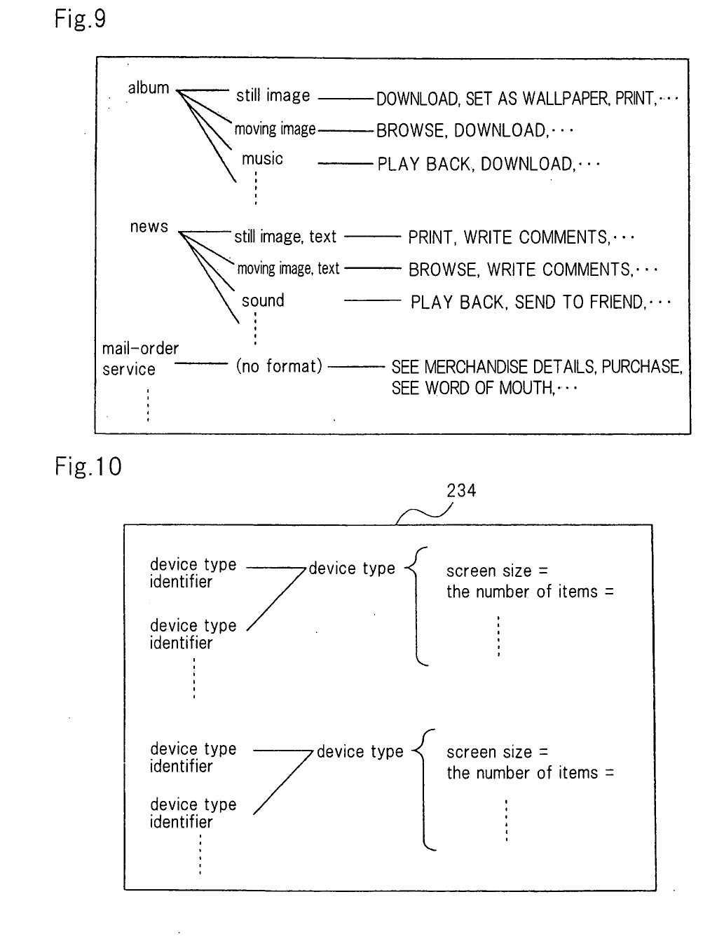

FIG. 8 is a table illustrative of format type item information. FIG. 9 is a view showing an example of the table shown in FIG. 8. The table shown in FIG. 8 includes category IDs, formats, and items that are successively described. When a category ID and a format are selected by referring to the table, items are determined. Items correspond to processing items to be executed by action means 228 of server 20.

If a category refers to an album, as shown in FIG. 9, then formats include a still image, a moving image, and music, and a plurality of items are described for each of the formats. If a format is a still image, then its items include ASP programs such as “DOWNLOAD”, “SET AS WALLPAPER”, “PRINT”, etc. and display data for buttons for executing those programs.

If a category refers to news and formats refer to a moving image and a text, then items include “BROWSE MOVING IMAGE”, “WRITE COMMENTS”, “SEND TO FRIEND”, etc. If a category refers to mail-order service, then there is no format, and items include “SEE MERCHANDISE DETAILS”, “PURCHASE”, “SEE WORD OF MOUTH”, etc. Therefore, items are provided depending on categories. For different formats under the same category, there are different items to choose from.

It has been described above that items are associated with category IDs and formats, so that items can be selected based on a category ID and a format which are associated with a contents ID. However, items may be associated with either category IDs or formats, and items may be selected based on either a category ID or a format which are associated with a contents ID.

FIG. 10 is a table showing an example of information about device types. As shown in FIG. 10, the table includes device type identifiers corresponding to display forms for the screens of display units of devices, device types, and information about display forms. The table may include not only information about display forms, but also information about items to be deleted and items to be added. The device type identifiers do not need to be represented by a string of characters such as device IDs, but may be represented by information indicating whether a device is a PC or a mobile terminal, i.e., information indicating the kind of a device. For example, since a display form can be identified from user agent information representing a web browser type and a version, such information may be used as device type identifiers, or information agreed on by device manufacturers may be used as device type identifiers. FIG. 10 shows that there are a plurality of device type identifiers for one device type. As screen sizes are different depending on device types, screen sizes and the number of items that can be displayed are described as information about display forms. For example, a comparison between a PC and a mobile terminal indicates that their screen sizes are widely different from each other.

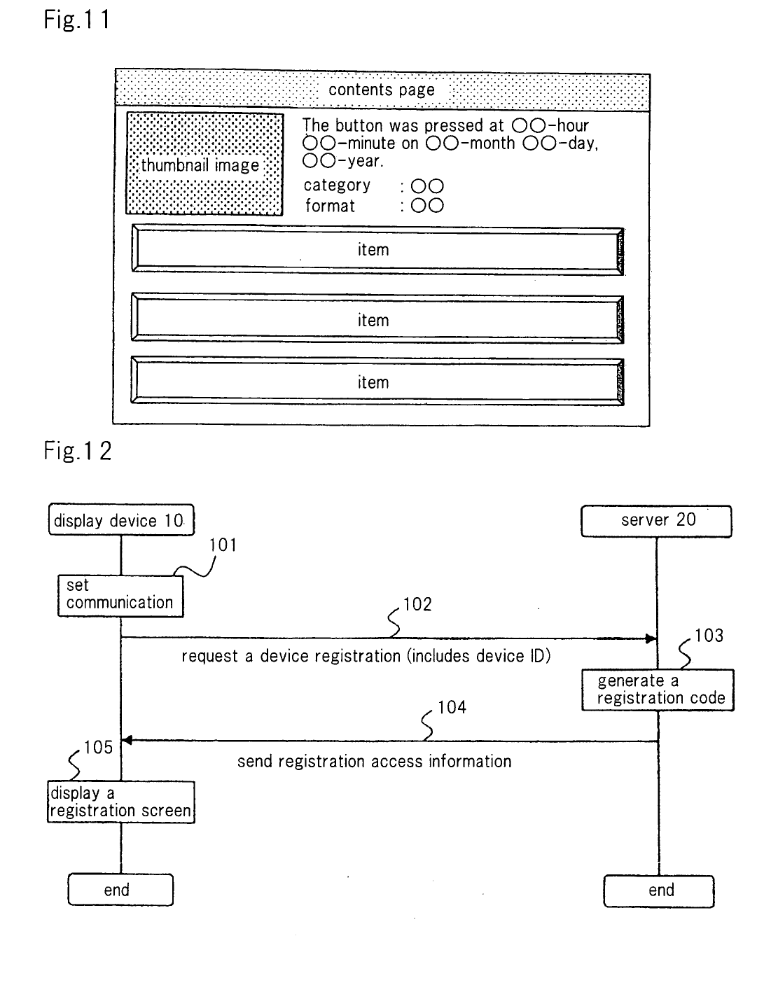

FIG. 11 is a view illustrative of a contents page. The page shown in FIG. 1 is illustrated by way of example. The contents page is a web page displayed on a browser. As shown in FIG. 11, the contents page includes the date when contents selection button 19 is pressed, a category, and a format. Contents selected by contents selection button 19 are displayed as a thumbnail image. Furthermore, buttons for selecting items corresponding to the contents are also displayed. The data of the contents page include, in addition to page data for displaying the contents data, information about a contents ID and item IDs as identifiers which are different from item to item.

Controller 22 includes contents storage means 221, registration accepting means 222, my page generating means 223 for generating a private page of the user, session ID generating means 224 for generating a session ID to be sent to and received from display device 10, contents sending means 225, page generating means 226 for generating a contents page, mail sending means 227 for sending a mail with information about the URL of a contents page, and action means 228 for carrying out a processing operation corresponding to a selected item. Details of operation of each of the above means will be described with reference to sequences to be described later.

Controller 22 includes a CPU (not shown) for carrying out processing operations according to programs, and a memory (not shown) for storing the programs. When the CPU executes the programs, contents storage means 221, registration accepting means 222, my page generating means 223, session ID generating means 224, contents sending means 225, page generating means 226, mail sending means 227, and action means 228 are virtually set up in server 20.

A process of recording an image to be displayed on display device 10 in server 20 will be described below.

The user operates information processing device 30 to store an image such as a photograph, a moving image, or the like captured by a digital camera in storage unit 33 of information processing device 30. When the user instructs information processing device 30 to send the image through input unit 37, information processing device 30 sends the image stored in storage unit 33 to server 20. Though the user uses information processing device 30 as a device for registering the image in server 20 in this process, the device for registering the image may be a device other than information processing device 30, such as a digital camera with a communication function.

When contents storage means 221 of server 20 receives the image from information processing device 30 via communication unit 21, contents storage means 221 assigns a contents ID to the received image, associating the image and the contents ID with each other. Then, contents storage means 221 distinguishes a format by identifying it either by referring to an extension such as jpg, mpg, way, or the like of the file or from data contents of the file, and stores the image and the contents ID in an area of storage unit 23 which is indicated by a contents storage URL. At this time, the contents storage URL which indicates the area where the image and the contents ID are stored is determined. The user registers the image using a user ID which has been assigned to the user in advance, and the registered contents are associated with the user ID.

A sequence for registering display device 10 on server 20 will be described below. FIG. 12 is a sequence diagram showing a sequence for registering display device 10 on server 20.

The user activates display device 10 and establishes communication settings in display device 10 (step 101). Registering means 121 of display device 10 reads the device ID from storage unit 13, encrypts a device registration request signal which is a signal for requesting a registration, including information about the device ID, according to a communication process such as https or the like, and sends the encrypted device registration request signal through communication unit 11 and network 50 to server 20 (step 102).

When registration accepting means 222 of server 20 receives the device registration request signal from display device 10 via communication unit 21, registration accepting means 222 reads the device ID included in the device registration request signal, and generates a registration code associated with the device ID (step 103). Registration accepting means 222 then sends registration access information including information about a registration screen URL which is a URL for accessing a registration screen and the registration code, to display device 10 (step 104).

When registering means 121 of display device 10 receives the registration access information from server 20 via communication unit 11, registering means 121 displays a registration screen including information about the registration code and the registration screen URL on display unit 15 (step 105).

The registration code will be described below. A registration code represents a one-time random string of characters which is issued by server 20 when display device 10 is to be registered in server 20. When information processing device 30 accesses server 20, the registration code displayed on display device 10 is used to certify that the person who has acquired the registration code using display device 10 and the person who connects information processing device 30 to server 20 are identical to each other. The device ID and the registration code are associated with each other, and stored in the user registration information shown in FIG. 5.

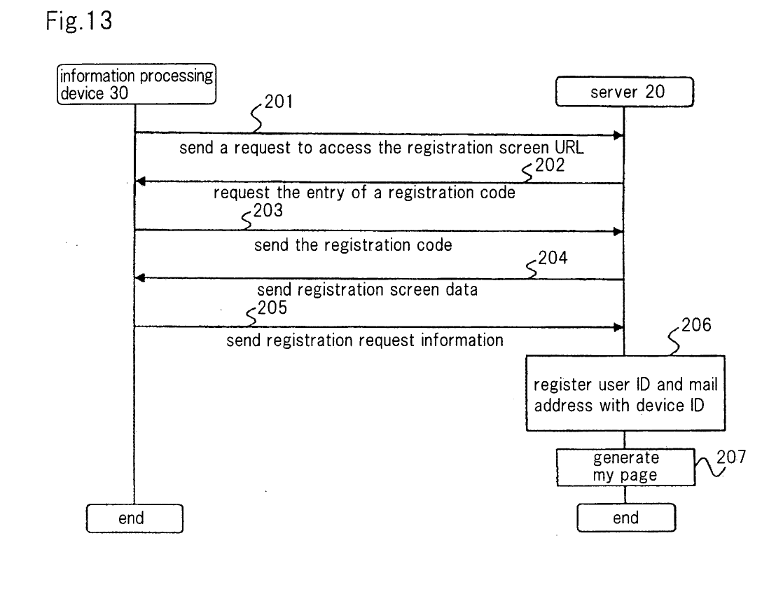

A sequence for registering the mail address of information processing device 30 in server 20 will be described below. FIG. 13 is a sequence diagram showing a sequence for registering the mail address of the information processing device.

When the user reads the registration screen URL displayed on display device 10 and enters the registration screen URL using input unit 37 of information processing device 30, registering means 321 of information processing device 30 sends a request to access the registration screen URL to server 20 via communication unit 31 (step 201).

When registration accepting means 222 of server 20 receives the access request from information processing device 30, registration accepting means 222 sends registration code request information including page data for requesting the entry of a registration code to information processing device 30 (step 202). When registering means 321 of information processing device 30 receives the registration code request information from server 20, registering means 321 displays a web page including a registration code entry field on display unit 35.

When the user operates input unit 37 of information processing device 30 to enter a registration code displayed on display device 10 in information processing device 30, registering means 321 of information processing device 30 sends the registration code to server 20 via communication unit 31 (step 203). When registration accepting means 222 of server 20 receives the registration code from information processing device 30 via communication unit 21, registration accepting means 222 checks whether or not a registration code which is the same as the received registration code is registered in the user registration information. If registration accepting means 222 confirms that the same registration code is registered in the user registration information, then registration accepting means 222 sends registration screen data including information about the registration code to information processing device 30 (step 204).

When registering means 321 of information processing device 30 receives the registration screen data from server 20 via communication unit 31, registering means 321 displays a registration screen on display unit 35. The user then enters the user ID, the password, and the mail address of information processing device 30 in the registration screen. At this time, if categories contracted for use have not been registered in advance, at least one category may be registered. It is assumed that a category to be utilized is selected by the user from a plurality of categories displayed in the registration screen.

Registering means 321 of information processing device 30 sends registration request information including information about a category ID corresponding to the selected category, the user ID, the password, the mail address, and the registration code to server 20 via communication unit 31 (step 205). When registration accepting means 222 of server 20 receives the registration request information from information processing device 30 via communication unit 21, registration accepting means 222 reads the information included in the registration request information, and identifies the read registration code and the registered device ID with the user registration information. Then, registration accepting means 222 stores the user ID, the password, the mail address, and the category ID, as well as the identified device ID, as the user registration information shown in FIG. 5, in storage unit 23 (step 206).

My page generating means 223 of server 20 generates my page, which is a home page for management that is unique to the user, with respect to the newly registered user registration information, for displaying and changing settings of the category corresponding to the registered category ID and various setting items with information processing device 30 (step 207), and stores the data of the generated my page in storage unit 23. My page generating means 223 writes a my page URL indicative of a location where the my page is saved, in the user registration information.

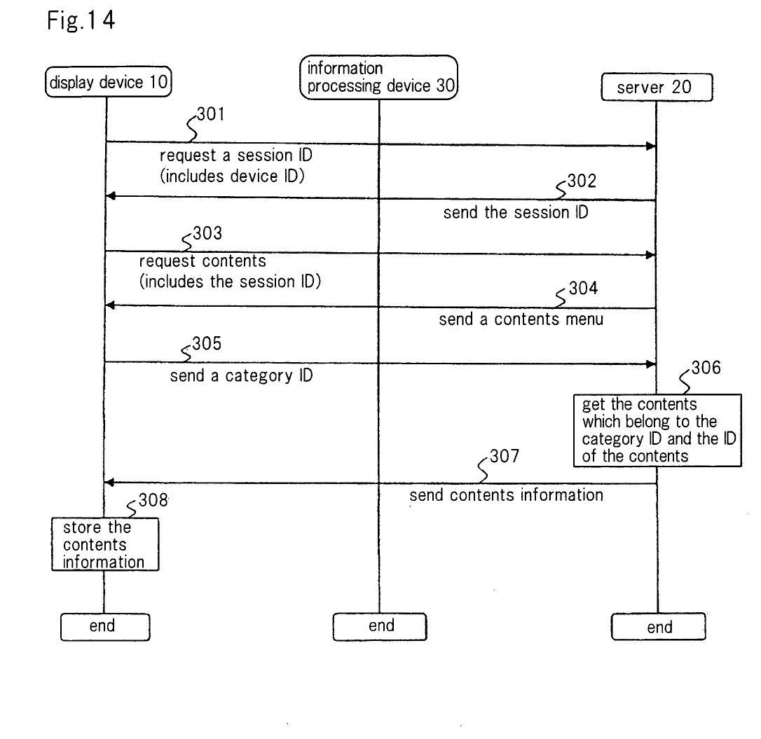

A sequence for acquiring contents from server 20 and goring the contents in display device 10 will be described below. FIG. 14 is a sequence diagram showing a sequence for storing contents in the display device. Display device 10 and server 20 send and receive information via network 50 according to the sequence shown in FIG. 14, without going through information processing device 30.

When the user turns on the power supply of display device 10, session ID managing means 122 of display device 10 determines whether or not a session ID is stored in storage unit 13. If a session ID is not stored in storage unit 13, or a session ID has expired, session ID managing means 122 connects to server 20 via communication unit 11, and sends a session ID request signal which is a signal for requesting a session ID, including information about the device ID, through encrypted communications (step 301).

When session ID generating means 224 of server 20 receives the session ID request signal from display device 10 via communication unit 21, session ID generating means 224 generates a session ID associated with the device ID included in the session ID request signal, and sends the session ID to display device 10 which has sent the session ID request signal, via communication unit 10 (step S302). When session ID managing means 122 of display device 10 receives the session ID from server 20 via communication unit 11, session ID managing means 122 stores the session ID in storage unit 13.

The session ID is an unencrypted ID which is time-limited (e.g., valid for 15 minutes) or rate-limited (e.g., 3 times). Though a session ID will be described as the identifier of display device 10, the device ID may be used rather than a session ID. For security reasons, a terminal ID needs to be encrypted for communications. A terminal identifier is required when commands for various functions are issued. If all of them are encrypted, then resources and responses tend to be adversely affected. Therefore, it is effective to use a session ID for time-limited communications. Server 20 may manage the expiry time of a session ID, and when the session ID is expired, server 20 may indicates the expiry of the session ID to display device 10, which may send the terminal ID to server 20 through encrypted communications to ask for a session ID.

After step 302, contents browsing means 123 of display device 10 connects to server 20 via communication unit 11 for communication, and sends a contents request signal including a session ID to server 20 (step 303). When contents sending means 225 of server 20 receives the contents request signal from display device 10 via communication unit 21, contents sending means 225 sends information about a contents menu which is a page for the user to select a category of contents such as image browsing, music listening, article browsing, an introduction of mail-order service merchandise, or the like, to display device 10 via communication unit 21 (step 304).

When contents sending means 225 of server 20 generates a contents menu, it may use a predetermined standard menu screen as the contents menu. However, contents sending means 225 may refer to the user registration information in storage unit 23 and change the menu screen based on the “category ID contracted for use” associated with the device ID which is identified from the session ID.

When display device 10 sends information to server 20, it includes the session ID in the information in order for server 20 to identify display device 10 which has sent the information. It is assumed that the signals and information sent from display device 10 server 20 include a session ID, and the session ID will not be described below. Conversely, when server 20 sends information to display device 10, server 20 may not add a session ID to the information to be sent.

After step 304, when contents browsing means 123 of display device 10 receives the information of the contents menu from server 20 via communication unit 11, contents browsing means 123 displays the contents menu on display unit 15. The user sees the contents menu displayed on display unit 15 of display device 10. When the user selects a category using operation keys 17, contents browsing means 123 sends a category ID corresponding to the selected category to server 20 via communication unit 11 (step 305).

When contents sending means 225 of server 20 receives the category ID from display device 10 via communication unit 21, contents sending means 225 refers to category type contents information 232 registered in storage unit 23 and reads a contents ID and a contents storage URL which are associated with the category ID. Then, contents sending means 225 reads contents from the contents storage URL (step 306), and sends contents information including the contents and the contents ID to display device 10 via communication unit 21 (step 307). It is assumed that contents information includes a contents storage URL and a contents ID, and contents may be sent later. When contents browsing means 123 of display device 10 receives the contents information from server 20 via communication unit 11, contents browsing means 123 stores the contents information in storage unit 13 (step 308).

When server 20 sends contents information to display device in step 306, if there are a plurality of contents and the amount of data thereof is large, then the contents information may not be sent all at once, but may be divided into smaller units and set in the units to display device 10.

If a category refers to an album and if contents represents an image captured by the user and not shared with other people, then contents sending means 225 of server 20 can refer to the user registration information, specify a device ID, a user ID, or a category ID which corresponds to the session ID, identify contents in storage unit 23 with the identified ID, and read the contents from storage unit 23.

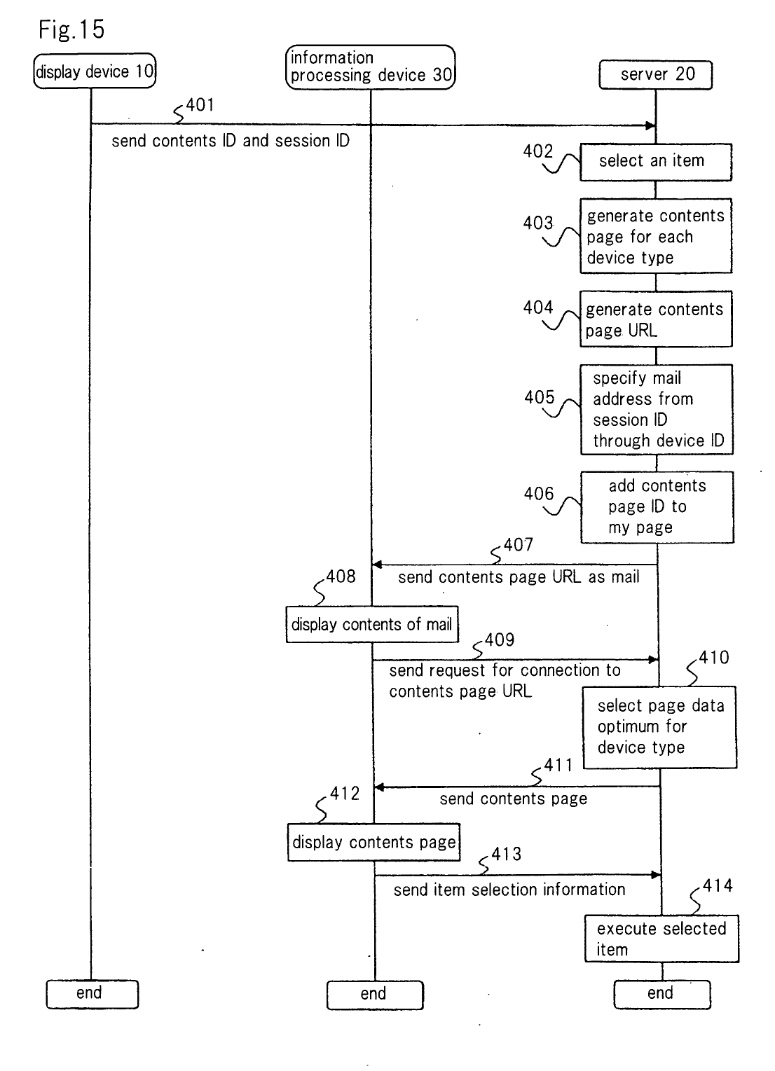

A sequence for acquiring an item about contents output to display device 10 with information processing device 30 will be described below. FIG. 15 is a sequence diagram showing a sequence for acquiring an item about contents output to the display device.

When contents browsing means 123 of display device 10 stores the contents information about a plurality of contents received from server 20 in step 308 shown in FIG. 14, in storage unit 13, contents browsing means 123 displays the contents in succession on display unit 15. When the user presses contents selection button 19 while contents which the user wants to select among the received contents are being displayed on display unit 15, contents browsing means 123 reads the contents ID corresponding to the contents displayed on display unit 15, and sends the contents ID and the session ID to server 20 via communication unit 11 (step 401).

When page generating means 226 of server 20 receives the contents ID and the session ID from display device 10 via communication unit 21, page generating means 226 refers to the category type contents information 232 in storage unit 23, and searches for a category ID to which the contents ID belongs and a format of the contents. Page generating means 226 also refers the category type contents information 232 and selects an item for generating a contents page, the item being associated the category ID and the format which agree with searching conditions (step 402).

The item is associated with the category ID and the format and selected according to the category ID and the format which are associated with the contents ID. However, an item may be associated either the category ID or the format and may be selected according to either the category ID or the format which are associated with the contents ID.

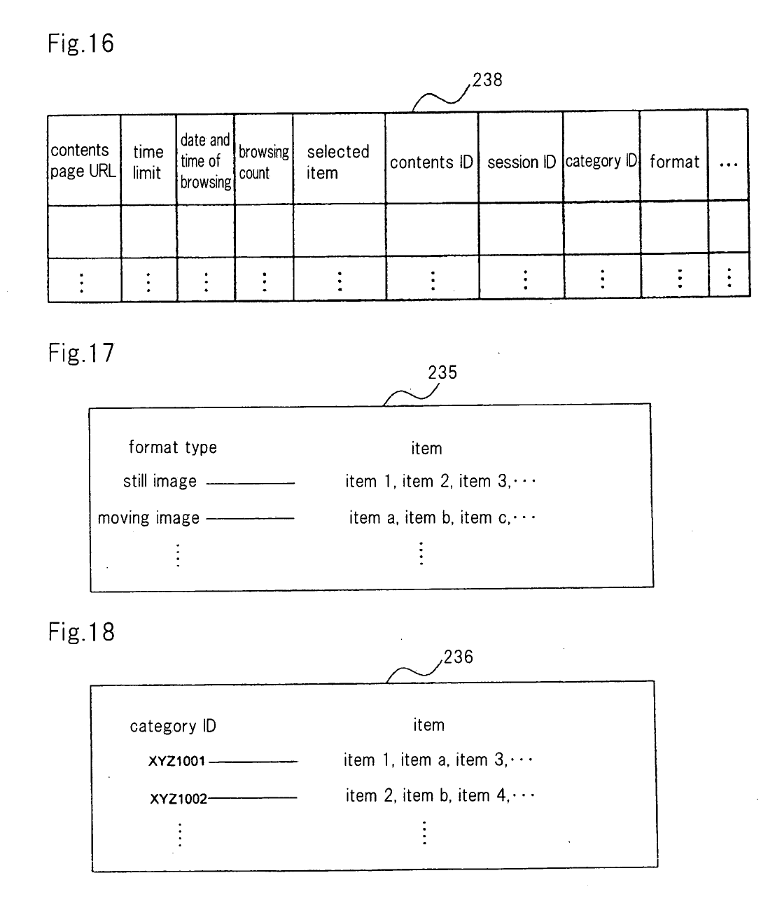

Then, page generating means 226 of server 20 refers to information 234 about device types, generates data of a contents page whose layout, screen size, script (Java script (registered trademark) or the like), flash and moving image formats and items (determined by addition and deletion) are optimized for each device type such as a PC, a mobile terminal, or the like, and stores the generated data in storage unit 23 (step 403). Page generating means 226 generates a contents page URL indicative of the location where the contents page is stored in storage unit 23, and registers the contents page URL in URL management table 238 (see FIG. 16) of storage unit 23 (step 404).

URL management table 238 will be described below. FIG. 16 is a diagram showing an example of URL management table 238. As shown in FIG. 16, URL management table 238 includes a contents page URL, a time limit, date and time of a browsing, a browsing count, a selected item, a contents ID, a session ID, a category ID, and a format, which are registered for each contents page. A rate limit may be registered rather than a time limit, and a device ID may be registered rather than a session ID.

The contents page URL generated in step 404 refers to only a URL portion which is shared by a plurality of contents pages generated for each device type. For each type of information processing device 30, “PC.htm” for a PC or “keitai.htm” for a mobile terminal is generated as data of a contents page, and its URL is generated as a shared URL portion such as “www.xxx.jp/” so that it can designate anything. Thereafter, the type of information processing device 30 to communicate with is identified, and if the device is a PC, the data of a content page are generated as “www.xxx.jp/PC.htm”.

A time limit or a rate limit may be added to a contents page and a contents page URL. When the limit is exceeded, the content page and its URL are deleted. Alternatively, the association between the contents page URL and the contents page may be deleted. If the contents page URL and the contents page remain saved in server 20 without being deleted, then they may possibly be accessed by people other than the user who exclusively uses the contents page. However, the contents page URL and the contents page are prevented from being accessed by those other people since controller 22 sets an effective time or an effective accessing count for the contents page and the contents page URL. Information about the effective time and the effective accessing count is pre-registered in storage unit 23.

When page generating means 226 of server 20 generates a contents page, it searches category type contents information 232 using a contents ID as a key, and extracts a category ID and a format. Thereafter, page generating means 226 may use format item information table 235 shown in FIG. 17 and category item information table 236 shown in FIG. 18. These tables are stored in storage unit 23 in advance.

FIG. 17 is a diagram showing an example of the format item information table. As shown in FIG. 17, format item information table 235 includes a plurality of items registered for each of the format types. FIG. 18 is a diagram showing an example of the category item information table. As shown in FIG. 18, category item information table 236 includes a plurality of items registered for each of the category IDs.

Page generating means 226 of server 20 refers to format item information table 235 and extracts item candidates from the formats. This extracting process is called a first extracting step. Page generating means 226 also refers to category item information table 236 and extracts item candidates from category IDs. This extracting process is called a second extracting step. Page generating means 226 then ANDs the item candidates extracted in the first extracting step and the item candidates extracted in the second extracting step, and determines items common to both candidate groups as items to be displayed. This process uses a table where formats and items are associated with each other and a table where categories and items are associated with each other, rather than format type item information 233 shown in FIG. 8.

After step 404, mail sending means 227 of server 20 derives a device ID corresponding to the session ID received from display device 10 from user registration information 231 stored in storage unit 23, and reads a mail address associated with the device ID from the user registration information (step 405). Mail sending means 227 then describes the contents page URL in mail data, and sends a mail to the mail address via communication unit 21 (step 406). Mail sending means 227 also refers to the user registration information, reads a my page URL associated with the device ID, reads URL management table 238 into HTML data of my page stored in storage unit 23, and adds link information of the contents page URL, a link information browsing date, and an effective browsing time limit (or a browsing count or an effective browsing count) (step 407).

My page is dynamically changed by my page generating means 223, reading a history of the link information of the contents page URL, the contents page URL browsing date, and the effective browsing time limit (or the browsing count or the effective browsing count) which are described in URL management table 238.

When mail means 322 of information processing device 30 receives the mail data from server 20 via communication unit 20, mail means 322 displays the contents of the mail on display unit 35 (step 408). When the user operates input unit 37 of information processing device 30 to enter an instruction to access the contents page URL, web browser means 323 of information processing device 30 detects that the contents page URL is designated, and sends a connection request signal for requesting a connection to the contents page URL to server 20 via communication unit 31 (step 409). At this time, web browser means 323 includes a device identifier of its own device in the connection request signal.

When page generating means 226 of server 20 receives the connection request signal for the contents page URL from information processing device 30 via communication unit 31, page generating means 226 determines the device type of information processing device 30 based on the device type identifier included in the connection request signal, by also referring to the information of the device type registered in storage unit 23. Page generating means 226 then selects the data of a contents page that matches the determined device type from storage unit 23 (step 410), reads the selected data of the contents page, and sends the read data of the contents page to information processing device 30 via communication unit 21 (step 411). The URL of the contents page is made up of the contents page URL for accessing a common contents page and the identifier (e.g., a file name) of a contents page corresponding to the device type. Page generating means 226 then updates the contents page URL browsing date (or the browsing count or the effective browsing count) in URL management table 238.

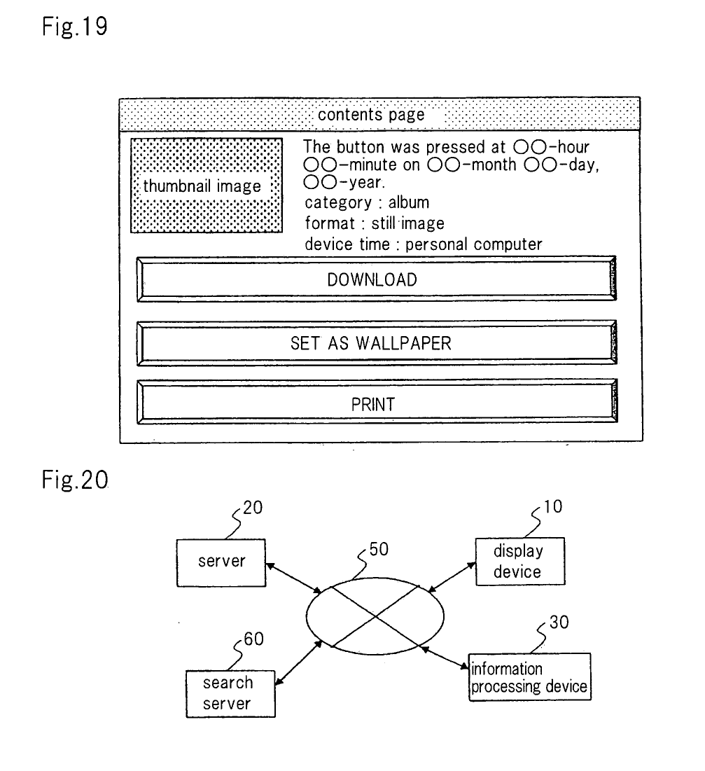

FIG. 19 is a view showing an example of a contents page. The example shown in FIG. 19 indicates that a category refers to an album, a format refers to a still image, and a device type refers to a PC, and also shows buttons representing “DOWNLOAD”, “SET AS WALLPAPER”, and “PRINT”.

Web browser means 323 of information processing device 30 displays the contents page received from server 20 via communication unit 31 on display unit 35 (step 412). When the user operates input unit 37 of information processing device 30 to select one of the items displayed in the contents page, web browser means 323 sends item selection information including the item ID and the content ID of the selected item to server 20 via communication unit 31 (step 413).

When action means 228 of server 20 receives the item selection information from information processing device 30 via communication unit 21, action means 228 reads the contents ID and the item ID included in the item selection information, and executes a program corresponding to the item ID on the contents corresponding to the contents ID (step 414).

In the above processing sequence, the item selection information is sent to server 20. However, the item selection information may be sent to controller 32 of information processing device 30, and a program corresponding to the item ID may be executed on the contents corresponding to the contents ID in information processing device 30.

In step 403 of the above processing sequence, the data of a contents page are generated for each device type in step 403. However, the data of a contents page that matches the determined device type may be generated using the items selected in step 402 in step 410.

In the present embodiment, one server 20 is provided. However, a plurality of servers may be provided, and the databases of the servers may comprise a network-compatible storage.

In the present embodiment, the contents comprise images. However, the contents may comprise images with sounds or may comprise sounds only. For example, if a music distribution service is involved, then the contents comprise music. Furthermore, the sequences that are carried out by information processing device 30 may be carried out by server 20.

According to the present embodiment, in response to pressing the contents selection button on the display device, a contents page which displays processing items is dynamically generated depending on the contents that are being output on the display device. Using the contents page, the contents that are being output on the display device can simply be processed by another device. Since the contents that are being output on the display device can be processed by another device other than the display device, the display device is prevented from becoming costly and large in size, and it is possible to process the contents that are being output on the display device simply in various ways.

If information about contents is sent from the display device to another information processing device via the server, then the contents can be processed by operating the information processing device. Therefore, the display device may comprise at least a means for outputting contents and a means for selecting contents. Since a contents page is dynamically generated for contents that are selected on the display device, it is not necessary to generate, in advance, a contents page which may not be browsed. Consequently, the capacity of the storage means of the server is prevented from being wasted.

### Second Exemplary Embodiment

According to the present exemplary embodiment, a screen including a character entry field is sent to an information processing device. Features according to the present exemplary embodiment which are different from the first exemplary embodiment will mainly be described below.

According to the present exemplary embodiment, the items of category type contents information 233 shown in FIG. 8 serve as character entry items. The character entry items refer to blog entry spaces or message board entry spaces, for example.

Operation according to the present exemplary embodiment will briefly be described below. Display device 10 includes only operation keys 17 and contents selection button 19 as an input means for the user. Therefore, it is inconvenient for display device 10 to enter characters. When contents selection button 19 is pressed, the URL of a contents page is sent to information processing device 30. According to the present exemplary embodiment, information processing device 30 displays the contents page which includes a character entry field. Since input unit 37 of information processing device 30 includes a keyboard and character input keys which serve as a character input means, the user can operate input unit 37 to enter characters in the character entry field of the contents page. According to the present exemplary embodiment, it is easy to enter characters when a contents page includes a character entry field.

### Third Exemplary Embodiment

The present exemplary embodiment comprises a search server added to the communication system according to the first exemplary embodiment. Those parts of the present exemplary embodiment which are identical to those of the first exemplary embodiment are denoted by identical reference characters, and will not be described in detail below.

FIG. 20 is a block diagram illustrative of a communication system according to the third exemplary embodiment of the present invention. The communication system according to the third exemplary embodiment includes search server 60 added to the communication system according to the first exemplary embodiment.

Operation of the present exemplary embodiment will be described below. When controller 22 of server 20 receives the contents ID from display device 10 in step 401 shown in FIG. 15, controller 22 reads a word related to the contents of the contents ID which are stored in storage unit 23, and sends the read word to search server 60. When a controller (not shown) of search server 60 receives the word related to the contents from server 20, the controller acquires information related to the word from information that is available on network 50, and sends the acquired information to server 20. The information that is received from search server 60 may include a URL for accessing the information. When controller 22 of server 20 generates a contents page in step 403, controller 22 generates items based on the information received from search server 60 and adds the generated items to the contents page.

According to the present exemplary embodiment, when the user selects the items generated from the search results, the user can easily acquire information available on the network with respect to the contents selected on display device 10.

### Fourth Exemplary Embodiment

According to the present exemplary embodiment, a server recognizes an information processing device at a stage before a contents page is generated.

In step 203 or 205 shown in FIG. 13, controller 32 of information processing device 30 sends a device type identifier to server 20. Based on the device type identifier received from information processing device 30, controller 22 of server 20 determines the display form of display unit 35 of information processing device 30, and stores information about the device type in association with the device ID in the user registration information.

In step 403 shown in FIG. 15, controller 22 generates the data of a contents page that matches the device type recorded in the user registration information, without generating a plurality of data of contents pages for each device type. In this case, it is necessary that the information processing device used when registering an electronic mail address and the information processing device used when browsing electronic mails be the same as each other.

According to the present exemplary embodiment, server 20 does not need to generate a contents page for each device type, and can dispense with the processing of step 410 shown in FIG. 15, thereby reducing the processing burden on server 20. Steps 407 through 409 can also be dispensed with, and an optimum contents page can be sent as an HTML mail in step 411. The operation of the information processing device by the operator can thus be simplified.

### Fifth Exemplary Embodiment

According to the first exemplary embodiment, a contents page for selecting a plurality of items is sent to the information processing device. According to the present exemplary embodiment, only one processing sequence is performed on contents. With a single processing item for contents, there is no need to send the URL of a contents page.

The user operates information processing device 30 to connect registering means 321 of information processing device 30 to my page stored in server 20, and selects, in advance, an item which is selected with a category and a format. According to such a setting registration, controller 22 of server 20 directly sends an URL on which the program of the selected item is to be executed, rather than sending a contents page URL to information processing device 30.

According to the present exemplary embodiment, when contents selection button 19 of display device 20 is pressed, information processing device 30 displays the button of an URL on which the program of the selected item is to be executed. When the display button is pressed, server 20 downloads contents into information processing device 30. The processing burden on both information processing device 30 and server 20 is thus reduced.

The second exemplary embodiment may be incorporated in the third through fifth exemplary embodiments.

The present invention may be applied to digital signage which corresponds to a display device installed in shops. When a person who has visited a shop finds a favorite piece of merchandise displayed on a display in the shop, the person reads a code such as a two-dimensional bar code displayed on the display into a mobile terminal, sends the code, instead of a contents ID, together with the device ID (session ID) of the mobile terminal to the server of a service provider, so that the information regarding the piece of merchandise will be received in the form of mail by an information processing device. In this application, the display in the shop and the mobile terminal are combined and applied as display device 10. If a prepaid card with a non-contact IC is assigned an identification number, then a mail address corresponding to the identification number is registered in advance. When a person who has visited a shop finds a favorite piece of merchandise displayed on a display in the shop, the person holds the prepaid card over a non-contact communication unit in the shop. Instead of the contents ID and the session ID of the piece of merchandise, the identification number that is read is sent from the display in the shop to the server, which then sends the information regarding the piece of merchandise to the mail address. In this application, the display in the shop is applied as display device 10.

In either one of the embodiments, the mail address of information processing device 30 may be registered in display device 10, and the mail address of information processing device 30 as well as the contents ID and the session ID may be sent to server 30 in step 401. Specifically, in steps 205, 206 shown in FIG. 13, rather than sending the mail address from information processing device 30 and registering the mail address in user registration information 231 in storage unit 23 of server 20, the mail address may be registered in display device 10.

According to an example of the advantages of the present invention, since contents output to a display device can be processed by a device other than the display device, the display device is prevented from becoming costly and large in size, and it is possible to process the contents that are being output on the display device simply in various ways.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2009-016601 filed on Jan. 28, 2009, the content of which is incorporated by reference.

### [Description of Reference Characters]

10 display device

20 server

30 information processing device

50 network

60 search server

12, 22, 32 controller

13, 23, 33 storage unit

15, 35 display unit

19 contents selection button

37 input unit

1. A communication system comprising:
a display device including a storage unit that stores a plurality of contents and contents identifiers which are different from contents, and a controller that successively outputs the contents and, when one of the contents is selected, sends a contents identifier corresponding to the selected one of the contents to a network; and
a server including a storage unit that stores processing items for the respective contents and a controller that, when said contents identifier is received from said display device via said network, generates a contents page including the processing item corresponding to the contents of said contents identifier.

2. The communication system according to claim 1, wherein said controller of the server sends information for acquiring said contents page to an information processing device via said network.

3. (canceled)

4. The communication system according to claim 2, wherein said information processing device has an electronic mail address registered in advance in the storage unit of said server; and
said controller of the server generates a uniform resource locator (URL) of the contents page as information for acquiring said contents page, and sends an electronic mail including the URL of the contents page to said electronic mail address.

5. The communication system according to claim 4, wherein when a controller of said information processing device registers said electronic mail address in said server, the controller of said information processing device sends a device type identifier corresponding to a display form of a screen of a display unit of the information processing device, to said server; and
said controller of the server registers said device type identifier received from said information processing device, as well as said electronic mail address, in said storage unit; and
when said controller of the server receives a connection request for requesting a connection to the URL of said contents page from said information processing device, after having sent said electronic mail to said information processing device, said controller of the server generates said contents page of the display form corresponding to said device type identifier of said information processing device.

6-7. (canceled)

8. The communication system according to claim 1, wherein the processing items which are stored in the storage unit of said server are classified according to both or one of the categories that are representative of service zones of the contents and formats that are representative of data recording forms of the contents.

9. The communication system according to claim 8, wherein when said controller of the server generates said contents page, said controller of the server refers to information stored in the storage unit of said server, extracts the category and the format which correspond to said contents identifier, and generates a contents page corresponding to the category and the format which are extracted.

10. (canceled)

11. A server device connected through a network to a display device for successively outputting a plurality of contents, comprising:
a storage unit that stores processing items for the respective contents; and
a controller that, when a contents identifier corresponding to a selected one of said contents is received from said display device, generates a contents page including the processing item corresponding to the contents of said contents identifier.

12. The server device according to claim 11, wherein said controller sends information for acquiring said contents page to an information processing device via said network.

13. (canceled)

14. The server device according to claim 12, wherein said information processing device has an electronic mail address registered in said storage unit; and
said controller generates a uniform resource locator (URL) of the contents page as the information for acquiring said contents page, and sends an electronic mail including the URL of the contents page to said electronic mail address.

15. The server device according to claim 14, wherein a device type identifier corresponding to a display form of a screen of a display unit of the information processing device, as well as said electronic mail address, is registered in advance in said storage unit; and
when said controller receives a connection request for requesting a connection to the URL of said contents page from said information processing device, after having sent said electronic mail to said information processing device, said controller generates said contents page of the display form corresponding to said device type identifier of said information processing device.

16. The server device according to claim 14, wherein when said controller generates said contents page, said controller generates contents pages of a plurality of respective display forms and stores the generated contents pages in said storage unit; and
when said controller receives a connection request for requesting a connection to the URL of said contents page from said information processing device, after having sent said electronic mail to said information processing device, and when said controller receives a device type identifier corresponding to a display form of a screen of a display unit of the information processing device, said controller selects one of the contents pages stored in said storage unit which corresponds to said device type identifier.

17. (canceled)

18. The server device according to claim 11, wherein the processing items which are stored in the storage unit are classified according to both or one of the categories that are representative of service zones of the contents and formats that are representative of data recording forms of the contents.

19. The server device according to claim 18, wherein when said controller generates said contents page, said controller refers to information stored in said storage unit, extracts the category and the format which correspond to said contents identifier, and generates a contents page corresponding to the category and the format which are extracted.

20. (canceled)

21. An information processing method carried out by a server device which is connected through a network to a display device for successively outputting a plurality of contents, comprising:
storing processing items for the respective contents; and
when a contents identifier corresponding to a selected one of said contents is received from said display device, generating a contents page including the processing item corresponding to the contents of said contents identifier.

22. The information processing method according to claim 21, further comprising:
sending information for acquiring said contents page to an information processing device via said network.

23. (canceled)

24. The information processing method according to claim 22, further comprising:
storing, in advance, an electronic main address of said information processing device;
generating a uniform resource locator (URL)of the contents page as the information for acquiring said contents page; and
sending an electronic mail including the URL of the contents page to said electronic mail address.

25. The information processing method according to claim 24, further comprising:
storing, in advance, a device type identifier corresponding to a display form of a screen of a display unit of the information processing device, as well as said electronic mail address; and
when a connection request for requesting a connection to the URL of said contents page is received from said information processing device, after having sent said electronic mail to said information processing device, generating said contents page of the display form corresponding to said device type identifier of said information processing device.

26. The information processing method according to claim 24, further comprising:
when said contents page is generated, generating contents pages of a plurality of respective display forms and storing the generated contents pages; and
when a connection request for requesting a connection to the URL of said contents page is received from said information processing device, after having sent said electronic mail to said information processing device, and when a device type identifier corresponding to a display form of a screen of a display unit of the information processing device is received, selecting one of the contents pages stored in said storage unit which corresponds to said device type identifier.

27. (canceled)

28. The information processing method according to claim 21, further comprising:
when the processing items are stored for each of said contents, classifying and storing the processing items according to both or one of the categories that are representative of service zones of the contents and formats that are representative of data recording forms of the contents.

29. The information processing method according to claim 28, further comprising:
when said contents page is generated, referring to stored information and extracting the category and the format which correspond to said contents identifier; and
generating a contents page corresponding to the category and the format which are extracted.

30-38. (canceled)
